(19) United States
(12) Patent Application Publication
(10) Pub. No.: US 2020/0141323 A1
(43) Pub. Date: May 7, 2020

(54) METHOD FOR STARTING-UP AND SHUTTING-DOWN A GAS TURBINE IN A COMBINED GAS AND STEAM POWER PLANT

(71) Applicant: Siemens Aktiengesellschaft, München (DE)

(72) Inventors: Stefan Becker, Adelsdorf (DE); Matthias Nickl, Erlangen (DE); Kai Voit, Lützelbach (DE); Johannes Walzik, Erlangen (DE)

(21) Appl. No.: 16/623,950

(22) PCT Filed: Jun. 4, 2018
(86) PCT No.: PCT/EP2018/064561

§ 371 Date: Dec. 18, 2019

(30) Foreign Application Priority Data
Jun. 19, 2017 (DE) 10 2017 210 194.6

(51) Int. Cl. F02C 7/26; F02C 9/22

(52) U.S. Cl. CPC F02C 7/26; F05D 2270/083; F05D 2260/85; F02C 9/22

(57) ABSTRACT

Provided is a method for starting and stopping a gas turbine in a combined cycle power plan, wherein the gas turbine includes a compressor having adjustable guide vanes and the gas turbine power can also be controlled by opening the guide vanes. When the gas turbine is started, it is driven up to a base load or up to an emission-compliant load point, and the guide vanes are opened before the base load or the emission-compliant load point is reached.

### CROSS-REFERENCE TO RELATED APPLICATIONS

This application claims priority to PCT Application No. PCT/EP2018/064561, having a filing date of Jun. 4, 2018, which is based off of DE Application No. 10 2017 210 194.6, having a filing date of Jun. 19, 2017, the entire contents both of which are hereby incorporated by reference.

### FIELD OF TECHNOLOGY

The following relates to a method for starting-up, but also for shutting-down, a gas turbine in a combined gas and steam power plant. In particular, embodiments of the invention relate to an operating regime for guide vane adjustment in the case of gas turbines.

### BACKGROUND

Typically, gas turbines in combined gas and steam power plants are ramped-up to a maximum value with guide vanes closed in the compressor. This has the advantage that the combustion in the gas turbine is stable, and the emissions are rapidly in a range that is specification-compliant. It is only upon attainment of the base load or following attainment of an emission-compliant load point, that the guide vanes are opened, in order to increase the mass flow through the gas turbine, and thus also the output power.

In the case of combined gas and steam power plants, however, ever higher gas-turbine exhaust-gas temperatures allow only a limited whole-plant quick-start capability. In particular, the waste-heat steam generator is subjected to considerable thermal stress, resulting in comparatively pronounced, premature material fatigue.

At present, therefore, the plant as a whole is started-up only gradually, including load holding points, by a temperature-controlled gas turbine start-up, until the maximum exhaust gas temperature is attained, including the output power holding points, for the purpose of preheating the downstream components (waste-heat steam generator, steam turbine).

### SUMMARY

An aspect relates to specify a method for starting-up and shutting-down a gas turbine in a combined gas and steam power plant, with which the plant can be started-up and shut-down as rapidly as possible, while being compliant with emission specifications and with the least possible fatigue of components downstream from the gas turbine.

An aspect is directed toward a method for starting-up and shutting-down a gas turbine in a combined gas and steam power plant, in that it provides that, in the case of such a method, the gas turbine comprises a compressor having adjustable guide vanes, and the gas-turbine output power can also be controlled by opening of the guide vanes, wherein the gas turbine, when being started-up, is operated up to base load or up to an emission-compliant load point, and the guide vanes are opened before the base load or the emission-compliant load point is attained.

As a result of the guide vanes being at least partly opened, the mass flow through the gas turbine is increased at an early stage, and the temperature of the exhaust-gas flow onto downstream components is reduced. To avoid excessive emissions, complete opening of the guide vanes is typically avoided in the comparatively early start-up time period.

It is expedient in this case if the gas turbine is ramped-up with a maximum possible load ramp. A start-up that is as rapid as possible is thus ensured.

It is advantageous if the guide vanes are closed at the beginning of the start-up operation, and during the start-up operation are opened as widely as possible, within the scope of the emission specifications, since a greater mass flow results in more output power, or lower temperatures of the exhaust-gas flow. It is essentially the “below” design operation of the plant that limits the degree of opening, because of the then poorer emission values.

It is advantageous if the combined gas and steam power plant comprises an exhaust-gas flue, and emissions are measured continuously in the exhaust-gas flue.

It is additionally advantageous if temperature sensors are read out continuously during starting-up and shutting-down. In particular, it is advantageous if the temperature sensors on thick-walled components are read out continuously, i.e. on components having an outer diameter to inner diameter ratio of greater than 1.2.

By means of the method of embodiments of the invention, the gas turbine is ramped-up with the maximum possible load ramp, without any further gas-turbine holding point, to base load or to the emission-compliant load point (e.g. 70% gas-turbine load) in a manner that is compatible, in respect of temperature, for the downstream components. Moreover, the operating regime for guide vane adjustment of the method of embodiments of the invention can also be used in the shut-down operation, in order to modify the gas-turbine exhaust-gas temperature with regard to the boiler service life.

The following advantages are obtained:
reduction of the waste-heat steam-generator stress load, and minimum waste-heat steam-generator service life consumption
reduction of the starting-up emissions (NOx)
improved and more flexible operation over the entire load range
more rapid start-up of the combined gas and steam power plant, including reduced fuel consumption
increased, more rapid provision of output power, due to the use of higher gas-turbine load ramps during the start-up operation

### BRIEF DESCRIPTION

Some of the embodiments will be described in detail, with reference to the following figures, wherein like designations denote like members, wherein:

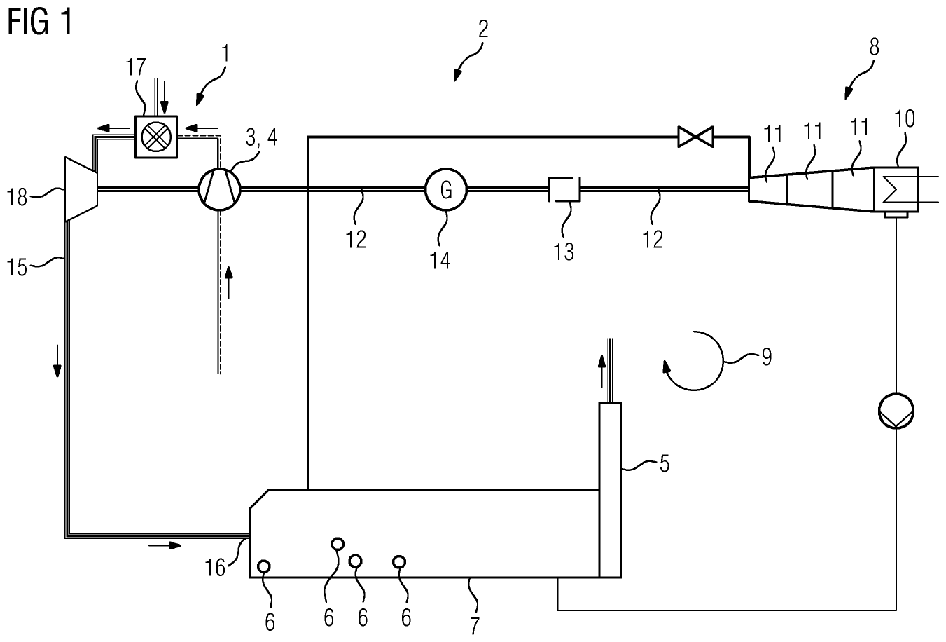

FIG. 1 shows a schematic representation of a combined gas and steam power plant; and

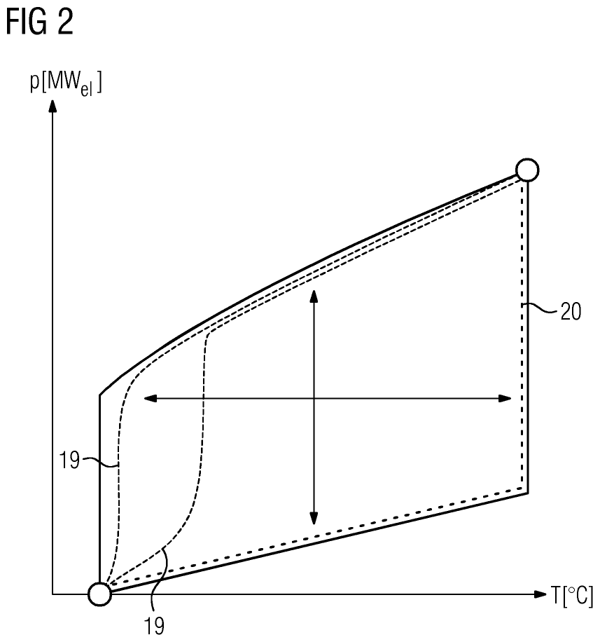

FIG. 2 shows a graph of the electrical output power of the combined gas and steam power plant over the exhaust-gas temperature.

### DETAILED DESCRIPTION

Shown in the schematic representation of FIG. 1 is a combined gas and steam power plant 2, having a gas turbine 1, a waste-heat steam generator 7 and a steam turbine 8. Other embodiments, such as, for example, two or more gas turbines, each having a downstream waste-heat steam generator, or even having a common waste-heat steam generator, are likewise possible.

The gas turbine 1 comprises a compressor 3, a combustion chamber 17 and a turbine 18. The compressor 3 comprises adjustable guide vanes 4, by means of which the compressor air mass flow can be set.

Downstream from the steam turbine 8, in a water-steam circuit 9, is a condenser 10. The water-steam circuit 9 additionally comprises the waste-heat steam generator 7, arranged in which, in particular on thick-walled components, are temperature sensors 6.

The steam turbine 8 usually comprises a plurality of pressure stages 11, which drive the generator 14, via a common shaft 12 that has a coupling 13.

For the purpose of supplying working fluid or flue gas, expanded in the gas turbine 1, into the waste-heat steam generator 7, there is an exhaust-gas line 15 connected to an input 16 of the waste-heat steam generator 7. The expanded working fluid from the gas turbine 1, i.e. the gas-turbine gas, exits the waste-heat steam generator 7 via an exhaust-gas flue 5.

FIG. 2 shows the electrical power output of the combined gas and steam power plant 2, represented over the exhaust-gas temperature, in the operating regime 19 of embodiments of the invention (two possible operating curves, indicated by broken line), in comparison with the former operating regime 20 (indicated by dotted line). In the case of the former operating regime 20, the guide vanes 4 remained closed until the gas turbine 1 was run up to base load or to an emission-compliant load point. This guaranteed a stable and emission-compliant combustion and, owing to the “low” exhaust-gas temperatures, as compared with present-day gas turbines 1, was the exemplary method. With the method according to embodiments of the invention, the mass flow through the gas turbine 1 is already increased before attaining the base load or an emission-compliant load point, as a result of which, inter alia, the temperature of the exhaust-gas flow is reduced.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for starting-up and shutting-down a gas turbine in a combined gas and steam power plant, wherein the gas turbine comprises a compressor having adjustable guide vanes, and the gas-turbine output power can also be controlled by opening of the guide vanes, wherein the gas turbine, when being started-up, is operated up to base load or up to an emission-compliant load point, wherein the guide vanes are opened before the base load or the emission-compliant load point is attained.

2. The method as claimed in claim 1, wherein the gas turbine ramped-up with a maximum possible load ramp.

3. The method as claimed in claim 1, wherein the guide vanes are closed at the beginning of the start-up operation.

4. The method as claimed in claim 1, wherein the guide vanes are opened as widely as possible, within the scope of the emission specifications.

5. The method as claimed in claim 1, wherein the combined gas and steam power plant comprises an exhaust-gas flue, and emissions are measured continuously in the exhaust-gas flue.

6. The method as claimed in claim 1, wherein temperature sensors are read out continuously during starting-up and shutting-down.

7. The method as claimed in claim 6, wherein the temperature sensors on thick-walled components are read out continuously, i.e. on components having an outer diameter to inner diameter ratio of greater than 1.2.
